(19) United States
(12) Patent Application Publication
(10) Pub. No.: US 2002/0139654 A1
(43) Pub. Date: Oct. 3, 2002

(54) TWO-STAGE SELF-LOCKING SWITCH STRUCTURE FOR HAND TOOLS

(76) Inventor: Jung-Chang Jong, Chungli City (TW)

Correspondence Address: Jason Z. Lin, 19597 Via Monte Drive, Saratoga, CA, 95070, US

(21) Appl. No.: 09/825,309

(22) Filed: Apr. 2, 2001

(51) Int. Cl. H01H 9/06

(52) U.S. Cl. 200/522; 200/318; 200/332.2

(57) ABSTRACT

A two-stage self-locking switch for electric hand tools mainly comprises a trigger base structure, an auto-return switch, a trigger-controlling structure, a trigger structure, and a cover for the trigger base structure. Wherein the trigger-controlling structure pivoted to the trigger base structure comprises mainly a button connected with an arresting part on its bottom and with a flexible slice on bottom of its front, and the flexible slice is connected with both a upward extending retaining key and a downward extending reversed hook plate. Whereas, the trigger structure is pivoted to the trigger base structure with respect to the position of the trigger-controlling structure, and on the appropriate positions of the front of the trigger structure corresponding to the arresting part and the reversed hook plate is provided with a resisting plate and a hook plate respectively. The interfering interaction between the arresting part and the resisting part can prevent hand tools from being mistakenly activated as a result of inattentively touching; or by hooking together the reversed hook plate and the hook plate, the action for activating switch can be hold and the hand tool can therefore be activated continuously. The main feature of the present invention is to install a trigger-controlling structure and a modified trigger structure, to provide a two-stage self-locking switch for electric hand tools equipped with two functions of self-locking for preventing inattentive activation and providing continuous activation, through which the safety and convenience of hand tools can be achieved.

### FIELD OF THE INVENTION

The present invention relates to a structure of a two-stage self-locking switch for electric hand tools, more particularly to a structure which can provide two self-locking functions for switches: preventing the switch from being mistakenly activated as a result of inattentively touching and enabling switches being activated continuously, through which the safety and convenience in using the hand tools equipped with switches can be enhanced.

### BACKGROUND OF THE INVENTION

The electric hand tools for trimming plants are equipped with switches providing the function of turning on and off power, to activate or stop the running of the motor. The prior art of the switches of the electric hand tools includes a trigger base structure, an auto-return switch, a trigger structure, and a cover for the trigger base structure. The traditional trigger structure of the electric hand tool is not equipped with the functions for preventing switch being inattentively activated and for enabling switches being activated continuously; and therefore, mistaken activation of the electric hand tools can easily lead to personnel injury in case of touching inattentively, and long hour of holding the trigger to activate the electric hand tools can be tiring and inconvenient.

Accordingly, the present innovation is to improve the shortcomings of the prior art of the electric hand tools.

### SUMMARY OF THE INVENTION

The object of the present invention is to provide a two-stage self-locking switch for electric hand tools, which employs a trigger-controlling structure mounted on the prior art of the electric hand tool and a trigger structure provided with a resisting plate and a hook plate with respect to the trigger-controlling structure. The arresting part provided in the trigger-controlling structure and the resisting plate mounted on the trigger are mutually obstructing each other at the original power-off status when the electric hand tool is not in use, preventing the hand tool from being mistakenly activated as a result of inattentively touching. Also, when the electric hand tool is in use, the electric hand tool can be activated continuously by hooking together the reversed hook plate provided at the trigger-controlling structure and the hook plate mounted on the trigger structure, without the need of holding the trigger structure in the duration of activation.

The present innovation and its aims and functions can be better understood with reference to the following figures.

### BRIEF DESCRIPTION OF THE DRAWINGS

FIG. 1 is an exploded perspective view of the structure of the two-stage self-locking switch for electric hand tools of the present invention.

FIG. 2 is a cross-section view for the assembled structure of the two-stage self-locking switch for electric hand tools of the present invention.

FIG. 3 is a cross-section view for the assembled structure of the two-stage self-locking switch for electric hand tools of the present invention with the trigger-controlling structure being pressed down.

FIG. 4 is a cross-section view for the assembled structure of the two-stage self-locking switch for electric hand tools of the present invention with the trigger-controlling structure being pressed down and the switch trigger being lifted up.

FIG. 5 is a cross-section view for the assembled structure of the two-stage self-locking switch for electric hand tools of the present invention with the reversed hook plate hooking the hook plate to enable the switch being activated continuously.

### DETAILED DESCRIPTION OF THE INVENTION

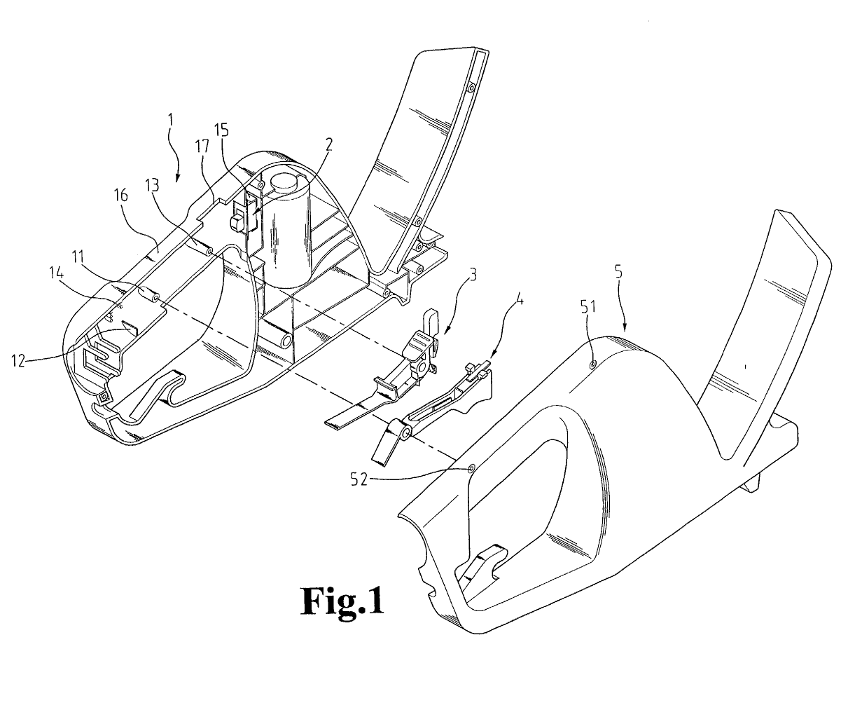

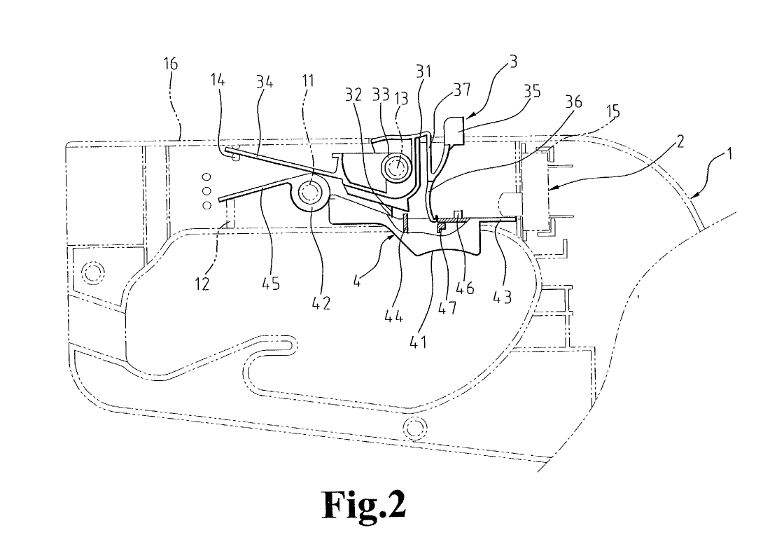

As illustrated with reference to FIGS. 1 and 2, one preferred embodiment of the two-stage self-locking switch for electric hand tools of the present invention comprises a trigger base structure 1, an auto-return switch 2, a trigger-controlling structure 3, a trigger structure 4, and a cover for the trigger base structure 5. The trigger base structure 1 comprises a hand hold 16 behind which a rear pivoting shaft 11, an counteractive plate 12, a front pivoting shaft 13, a counteractive rod 14, a switch seat 15, and an opening 17 are provided at appropriate position, wherein the auto-return switch 2 is arranged at the switch seat 15. Whereas, the trigger-controlling structure 3 mainly comprises a button 31 pivoted to the front pivoting shaft 13 by a pivot 33. On the rear side of the button 31 is provided with an elastic slice 34 of which the other end is mounted on the top of the counteractive rod 14, on the front bottom of the button 31 is provided with a gear-like arresting part 32, and on the bottom of the button 31 is connected with a flexible slice 37 of which bottom is fixed both to a upward extending retaining key 35 and a downward extending reversed hook plate 36. The trigger structure 4 mainly comprises a trigger switch 41 of which rear part is a trigger pivot 42 pivoted to the rear pivoting shaft 11, and the rear part of the trigger pivot 42 is an elastic slice of trigger 45 contacted against the arresting plate 12. The front of the trigger structure 4 is provided with a switch plate 43 contacted against the lower part of the self-return switch 2; the two sides of the front of the trigger structure 4 is fixed respectively a restricting plate 46 to serve as the lowest limit which the trigger switch 41 can move downwards; at the appropriate position on the interlayer of the front of the trigger structure 4 is provided with a reversed ladder-like hook plate 47, and a resisting plate 44 is arranged at the back of the hook plate 47. And the trigger base structure 5 is a near symmetric stricture with the trigger structure 1, wherein on its top is arranged with a through hole 51 and a through hole 52 which can be fastened with the rear pivoting shaft 1 land the front pivoting shaft 13 of the trigger structure 1 by screws, respectively.

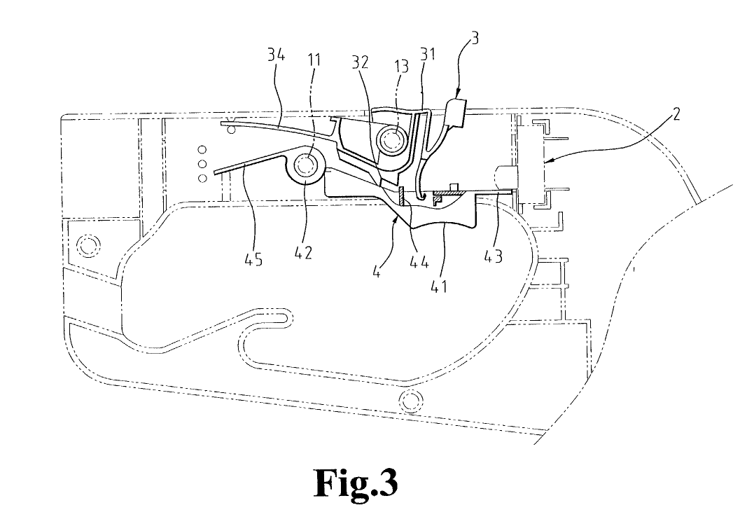

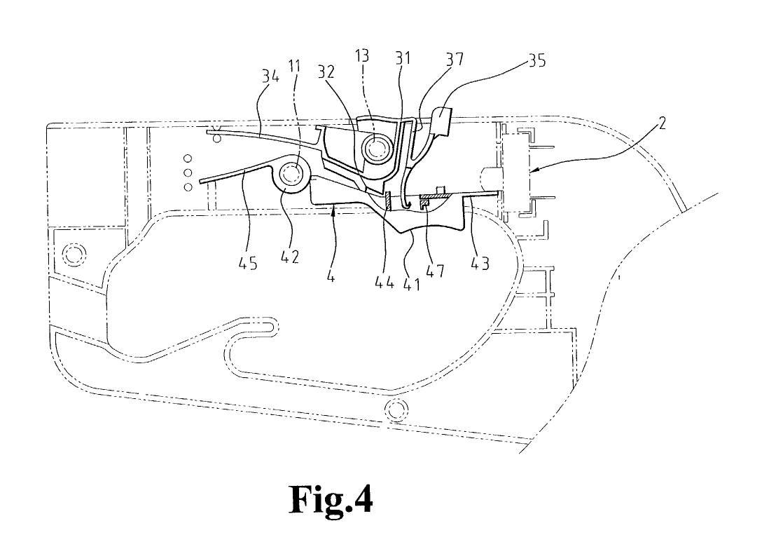

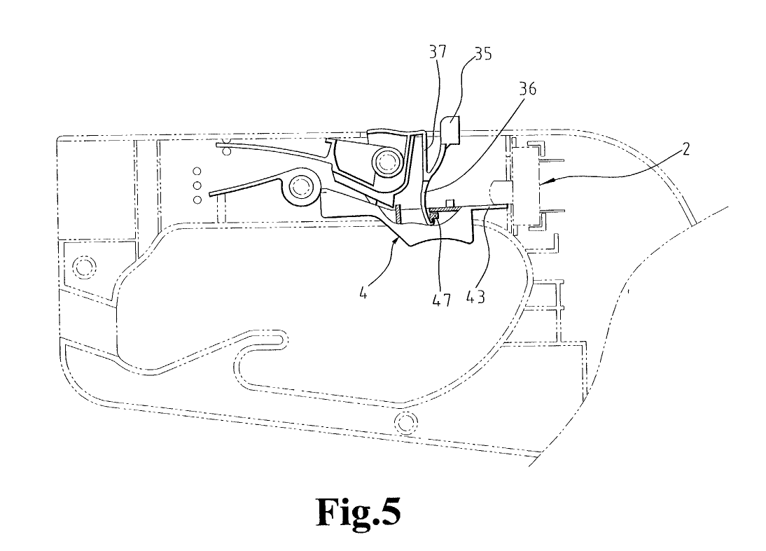

As illustrated with reference to FIG. 2, one preferred embodiment of the present invention, the two-stage self-locking switch for electric hand tools, in case of the button 31 not being pressed down, the arresting part 32 of the trigger-controlling structure 3 can block the upward movement of the resisting plate 44 driven by the upward-moving trigger switch 35, and therefore the trigger switch 35 is unable to move upwards. As illustrated with reference to FIGS. 3 and 4, if the button 31 being pressed down, the resisting plate 44 can move upwards easily without the hindrance of the arresting part 32, and the auto-return switch 2 is in turn driven to ON status by the switch plate 43. If again release the trigger switch 41 and the button 31, the upward movement of the trigger switch 41 can make the trigger pivot 42 rotate around the rear pivoting shaft 11, a certain amount of residual elastic force is generated on the deformed elastic slice of trigger 45 which in turn prompts the trigger switch 41 to drive the switch plate 43 back to its original position; the auto-return switch 2 will also return to the OFF status after losing the supporting force. In the mean time, the button 31 and the arresting part 32 situated above the button 31 will also return to their original positions. Furthermore, as illustrated with reference to FIG. 4, in the case of pressing down the button 31 and moving the trigger switch 41 upwards to drive the auto-return switch 2 to ON status, move the retaining key 35 backwards (as shown in FIG. 5) will cause the flexible slice 37, pivoting on its one side according to the lever rule, to prompt the reversed hook plate 36 moving forwards to hook to the ladder-like hook plate 47; at this moment, if releasing the trigger switch 41 and the button 31, the trigger structure 4 and the trigger-controlling structure 3 will not return to their original positions because the hook plate 47 is hooked to the reversed hook plate 36, making the auto-return switch maintain at the ON status continuously. But, if the button 31 is being pressed down, the reversed hook plate 36 will release the hook plate 47, making the trigger structure 4 and the trigger-controlling structure 3 return to their original positions and, in turn, the auto-return switch will return to OFF status.

It should be understood that the above only describes an example of one embodiment of the present invention, and that various alternations or modifications may be made thereto without departing the spirit of this invention. Therefore, the protection scope of the present invention should be based on the claims described later.

What is claimed is:

1. A two-stage self-locking switch for electric hand tools comprising:
a trigger base structure;
an auto-return switch arranged in said switch seat;
a trigger-controlling structure pivoted to said switch seat, wherein said trigger-controlling structure provided with at least an arresting part and an elastic slice, and said trigger-controlling structure connected to the rear part of said switch seat so as to secure said elastic slice to said switch seat;
a trigger structure, pivoted to said switch seat, comprising a triggering switch of which top is provided with a resisting plate, on both ends of said resisting plate are arranged with a switch plate and an elastic slice of trigger respectively, making said elastic slice of trigger contact said trigger base structure; by the described structure, when no external force is applied to said trigger structure, said arresting part sets against said resisting plate, making said trigger switch unable to be pressed; by pressing said trigger-controlling structure to turn said arresting part aside and move away from said described resisting plate, making said trigger switch able to be pressed.

2. A two-stage self-locking switch for electric hand tools according to claim 1, wherein said trigger structure is arranged with an downward extending flexible slice, lower end of said flexible slice is provided with a reversed hook plate, on the top of said trigger structure is provided with a hook plate, and upon pressing said trigger structure and said trigger switch one by one, said reversed hook plate will hook to said hook plate and in turn maintain said trigger structure at PRESS status, while turning said trigger structure to the opposite direction can separate said reversed hook plate and said hook plate.

3. A two-stage self-locking switch for electric hand tools according to claim 1, wherein said elastic slice and said trigger-controlling structure are manufactured as a integral part.

4. A two-stage self-locking switch for electric hand tools according to claim 1, wherein said elastic slice of trigger and said trigger structure are manufactured as a integral part.
